(19) United States
(12) Patent Application Publication
(10) Pub. No.: US 2006/0029029 A1
(43) Pub. Date: Feb. 9, 2006

(54) Apparatus and method capable of wireless communication using channel management

(76) Inventor: Eric A. Jacobsen, Scottsdale, AZ (US)

Correspondence Address: INTEL CORPORATION, P.O. BOX 5326, SANTA CLARA, CA, 95056-5326, US

(21) Appl. No.: 10/914,581

(22) Filed: Aug. 9, 2004

(51) Int. Cl. H04J 1/00

(52) U.S. Cl. 370/343; 370/208; 370/338

(57) ABSTRACT

An apparatus, comprising a transceiver capable of wireless communication between said apparatus and at least one wireless device using subcarrier alignment or partial subcarrier alignment, wherein said subcarrier includes a predetermined preamble that is detectable by said at least one wireless device and said apparatus.

### BACKGROUND

Future wireless devices may have vastly different needs for channel resources, especially channel bandwidth, depending on their throughput requirements. A video transport may require large bandwidth allocations to support the high video data rates, while a PDA used for email or rudimentary web surfing may require much lower data rates, and a VoIP phone even less. Similarly different usage models suggest different system requirements, with hotspots and enterprise deployments requiring heavy frequency reuse with lower point-to-point throughputs, and residential applications requiring little or no frequency reuse but potentially high device throughputs. This suggests that different deployments may wish to use wider channels than others depending on the expected devices or usage model encountered.

Coexistence and management of available channel resources for devices using differing bandwidths in the same spectrum presents unique challenges. Thus, there is a continuing and strong need in the wireless industry to improve the management of channel resources.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of the channel usage of different devices with different bandwidths using subcarrier alignment of one embodiment of the present invention; and

FIG. 2 is an illustration of one preamble strategy of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN) or wide are networks (WAN), or personal area networks (PAN, and the like).

The present invention provides, in one embodiment, a method of efficiently managing channel use among OFDM devices which may have differing channel bandwidths without the need for coordination between the disparate devices. However, it is understood that the present invention is not limited to OFDM devices.

Most systems with devices that use common spectrum and differing bandwidths either do not have the capability of mutual detection or require some central coordinator that may configure or communicate with all cooperating devices. One embodiment of the present invention provides for the capability of fundamental mutual awareness that also allows each device to know what portions of the spectrum are occupied by other devices. This may allow each device to more quickly find unoccupied spectrum and may facilitate simplified full interoperation between devices.

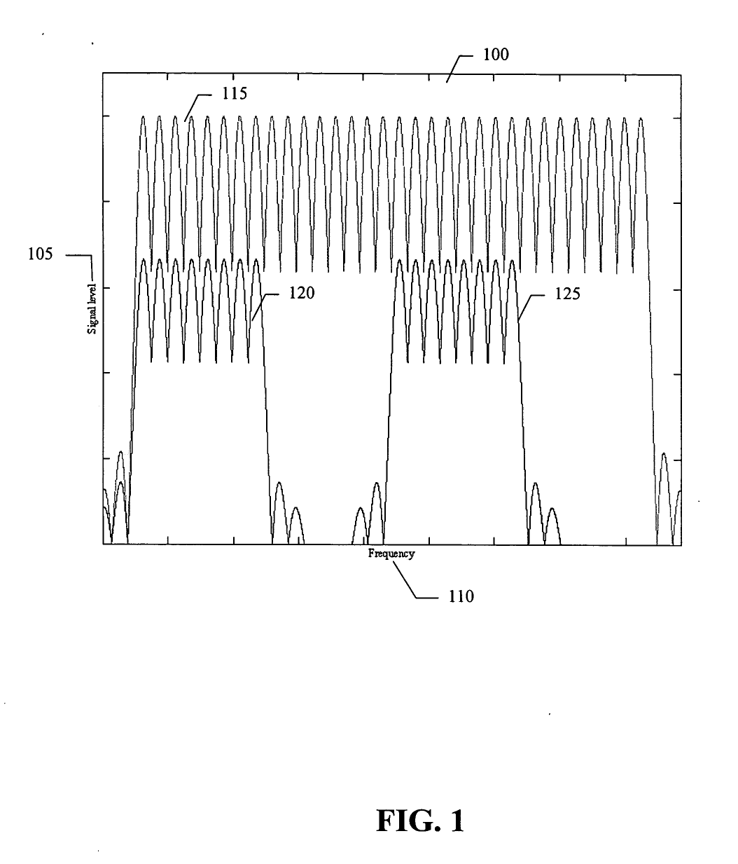

Although the present invention is not limited in this respect , in one embodiment of the present invention, FIG. 1, shown generally as 100, illustrates the use of subcarrier alignment between devices using differing bandwidths in signal level 105 vs. frequency 110. Typically, it may be possible to assign subcarrier center frequencies such that different devices may select channels by aggregating subcarriers, such as 120 and 125 or blocks of subcarriers, while maintaining alignment with other devices. Further, modern oscillators may have high stability and low cost and typical LAN subcarrier widths may be much greater, such as at 115, than any expected tuning uncertainty. With subcarrier alignment, devices may more easily detect each other's preambles or portions of each other's preambles or signaling and gain insight into spectrum occupation and local coexistence requirements.

Additionally, even in the absence of other discernable devices, one device may elect to use a quantity or arrangement of subcarriers that best avoids other uncooperative interferers or other channel impairments. Although the present invention is not limited in this respect, devices may also obtain more bandwidth by incrementally increasing the number of subcarriers used and populating them in the least faded or interfered portions of the spectrum.

Subcarrier alignment among similar devices using different bandwidths may also allow detection or partial detection of preambles. This may allow unique identification, even if only a portion of the preamble is detectable. It may also provide information as to the bandwidth and center frequency of the device and potentially additional information that can be encoded in the preamble.

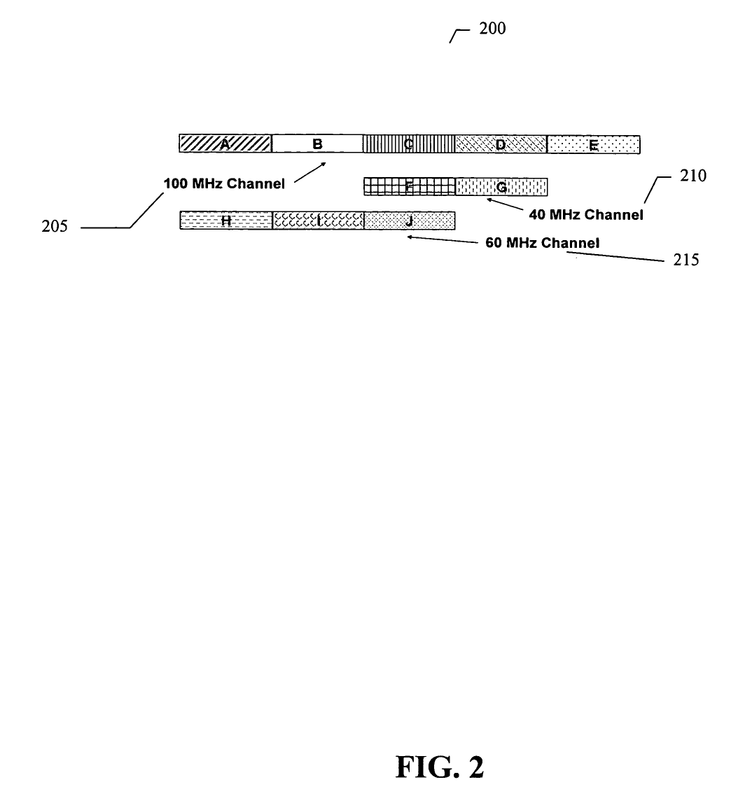

Turning now to FIG. 2, shown generally as 200, is a possible arrangement of one embodiment of the present invention in which devices use multiples of 20 MHz channelization. However, the present invention is not limited to these multiples or any particular multiples. Each device may use a predetermined preamble that is detectable by every other device with overlapping spectrum. The preambles may provide good channel estimation and/or synchronization properties, and each 20 MHz section may differ potentially only in phase alignment, cyclic shift, or some other easily detectable variation that can be simply demodulated. However, the present invention is not limited to these differences in 20 MHz sections.

In the embodiment of FIG. 2 is one possible preamble strategy which occupies 20 MHz segments and may be uniquely detectable by other devices. The device with 100 MHz channel width 205 may detect the preambles (and potentially the signaling) of the 40 MHz 210 and 60 MHz 215 devices. The 40 MHz 210 device may detect segment C and D of the 100 MHz device 205, and also segment J of the 60 MHz device 215 (and thereby knows its channel width and center frequency of each). If the shown preamble segments are exclusively used by devices of the indicated channel widths, then any other device need only detect a single 20 MHz portion of any of the preambles to know the occupied channel width and center frequency of each device. Again, the 20 MHz segments may all differ by cyclic shift, inversion, phase rotation, or some other property that may be uniquely discerned using a minimal amount of demodulator complexity. Again, the present invention is not limited to these differences in 20 MHz sections. Although the present invention is not limited in this respect, this detectability may be facilitated by each device using common subcarrier alignment and symbol duration.

Although the present invention is not limited in this respect, once devices have detected each other they may choose to move to other unoccupied spectrum, reconfigure to match the other device, implement a mutual co-channel avoidance strategy, or attempt to fully communicate with the other device. This scheme may be extended to allow rudimentary signaling between disparate devices in an attempt to reconfigure one or both ends of the link to facilitate network admission or full communication.

Although specific frequency segments have been used herein in one embodiment of the present invention for illustration purposes, it is understood that it is within the scope of the present invention to use any segmentation in any frequency spectrum.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a transceiver capable of wireless communication between said apparatus and at least one wireless device using subcarrier alignment or partial subcarrier alignment, wherein said subcarrier includes a predetermined preamble that is detectable by said at least one wireless device and said apparatus.

2. The apparatus of claim 1, wherein the communication between said apparatus and said at least one wireless device uses Orthogonal Frequency Division Multiplexing (OFDM).

3. The apparatus of claim 1, wherein said at least one wireless device is a plurality of wireless devices and wherein the communication between said apparatus and said plurality of wireless devices uses Orthogonal Frequency Division Multiplexing (OFDM) with differing channel bandwidths.

4. The apparatus of claim 3, wherein the communication between said apparatus and said plurality of wireless devices selects channels by aggregating subcarriers or blocks of subcarriers while maintaining alignment with other devices.

5. The apparatus of claim 4, wherein all of said plurality of wireless devices use subcarrier alignment enabling the capability of detecting each other's preambles or portions of each other's preambles or signaling and thereby providing information relating to spectrum occupation and local coexistence requirements.

6. The apparatus of claim 3, wherein said at least one wireless device uses a quantity or arrangement of subcarriers that best avoids other uncooperative interferers or other channel impairments.

7. The apparatus of claim 1, wherein the communication between said apparatus and said at least one wireless device may obtain more bandwidth by incrementally increasing the number of subcarriers used and populating them in the least faded or interfered portions of the spectrum.

8. The apparatus of claim 3, wherein said plurality of wireless devices which use subcarrier alignment use common subcarrier waveforms to more easily detect each other's presence and configuration.

9. The apparatus of claim 1, wherein said preamble provides information about said at least one wireless device.

10. The apparatus of claim 9, wherein said information is obtained even if only a portion of said preamble is detectable and is a unique identification of said at least one wireless device.

11. The apparatus of claim 9, wherein said information is obtained even if only a portion of said preamble is detectable and said information is the center frequency of said at least one wireless device.

12. The apparatus of claim 1, wherein said subcarrier alignment is in 20 MHz segments and differ by cyclic shift, inversion, phase rotation.

13. The apparatus of claim 3, wherein each device of said plurality of wireless devices uses a common subcarrier alignment and symbol duration.

14. The apparatus of claim 1, wherein once said apparatus and said at least one wireless device detect each other, they may:
move to other unoccupied spectrum;
reconfigure to match the other device;
implement a mutual co-channel avoidance strategy; or attempt to fully communicate with the other device.

15. A method of wireless communication, comprising:
using subcarrier alignment or partial subcarrier alignment to communicate between an apparatus and at least one wireless device, wherein said subcarrier includes a predetermined preamble that is detectable by said at least one wireless device and said apparatus.

16. The method of claim 15, further comprising using Orthogonal Frequency Division Multiplexing (OFDM) with differing channel bandwidths in said wireless communication.

17. The method of claim 15, further comprising aggregating subcarriers or blocks of subcarriers while maintaining alignment with other devices for channel selection.

18. The method of claim 15, further comprising enabling the capability of detecting each other's preambles or portions of each other's preambles or signaling and thereby providing information relating to spectrum occupation and local coexistence requirements.

19. The method of claim 15, further comprising using a quantity or arrangement of subcarriers by said at least one wireless device that best avoids other uncooperative interferers or other channel impairments.

20. The method of claim 15, further comprising increasing incrementally the number of subcarriers used and populating them in the least faded or interfered portions of the spectrum.

21. The method of claim 15, further comprising using common subcarrier waveforms.

22. The method of claim 15, further comprising providing information about said at least one wireless device in said preamble.

23. The method of claim 15, further comprising providing a unique identification of said at least one wireless device.

24. An article comprising a storage medium having stored thereon instructions, that, when executed by a computing platform, results in the control of a transceiver capable of wireless communication between an apparatus and at least one wireless device using subcarrier alignment or partial subcarrier alignment, wherein said subcarrier includes a predetermined preamble that is detectable by said at least one wireless device and said apparatus.

25. The article of claim 24, wherein said at least one wireless device is a plurality of wireless devices and wherein the communication between said apparatus and said plurality of wireless devices uses Orthogonal Frequency Division Multiplexing (OFDM) with differing channel bandwidths.
